(19) United States
(12) Patent Application Publication
(10) Pub. No.: US 2003/0208889 A1
(43) Pub. Date: Nov. 13, 2003

(54) Titanium cremation urn and method of making and using the same

(76) Inventor: Mitchell Z. Dziekonski, Sugar Land, TX (US)

Correspondence Address: LOCKE LIDDELL & SAPP LLP, 600 TRAVIS, 3400 CHASE TOWER, HOUSTON, TX, 77002-3095, US

(21) Appl. No.: 10/461,049

(22) Filed: Jun. 13, 2003

Related U.S. Application Data
(63) Continuation-in-part of application No. 09/923,014, filed on Aug. 3, 2001, now abandoned.

(51) Int. Cl. A61G 17/00

(52) U.S. Cl. 27/1

(57) ABSTRACT

The present invention offers a titanium cremation urn that may be used in a variety of environments, including outdoor, semi-outdoor, water, or marine environments without the concern of corrosion and fermentation problems seen in the prior art. In a preferred embodiment, the present invention may comprise titanium, and its principal alloys, coatings of these metals. In a most preferred embodiment, an urn formed of titanium offers a preferred urn for the cremated remains of a deceased human or animal. In a most preferred embodiment, the urn may further include a compartment for the inclusion of objects. This invention offers a lightweight urn that is also advantageous for portability and mobility.

This application is a continuation-in-part application of U.S. patent application Ser. No. 09/923,014 filed Aug. 3, 2001.

### SPECIFICATION

1. Field of the Invention

This invention relates to cremation urns for use in the funeral and death care industry.

2. Background of the Invention

Cremation urns for the cremains of loved ones and animals of loved ones are known in the art. Notably, most of these urns have been fashioned from substances that discolor, degrade, or corrode over time. Sometimes, this degradation is helpful for environmental reasons. Though efforts have been made to incorporate paper, wood, plastics, copper, bronze, steels, and stainless steels in the design of these urns, there exists a need to provide an urn comprised of a material that is corrosion resistant and is virtually immune to environments including but not limited to outdoor environments, semi-outdoor environments such as columbariums, niches, and mausoleums, water and marine environments.

Urns are currently limited to indoor environments, since they are also prone to corrosion attack that affects the aesthetic look of the unit. Urns can be manufactured from brass, bronze, copper, stone, or glass. Metallic urns made of steel, stainless steel, bronze, or copper are placed in vaults in outdoor crypts, but have a limited life in terms of corrosion resistance. Atmospheric conditions, as well as acid rain can have a degrading affect on the appearance of urns placed in an outdoor or marine environment. Moreover, biological organisms and their excretions may come into contact with the metals and corrode them.

Moreover, outdoor, semi-outdoor, and water environments offer additional challenges. For example, the presence of chlorides or other halides can offer a corrosive situation in various alloys, such as stainless steels. The highly corrosive nature and widespread abundance of seawater and sea air have led to extensive efforts to find materials that are resistant to chlorides.

Commercial stainless steels are also subject to localized corrosion in stagnant seawater. Stagnant conditions arise when the flow rate over the metallic surfaces is less than about 1.2 to about 1.6 meters per second (about 3.9 to about 5.2 feet per second), when marine organisms are attached to the surfaces, or where crevices exist. Such conditions are very difficult to avoid completely in actual practice.

Thus, although general corrosion of stainless steel components tends to be very low in seawater, very serious damage leading to early failure often occurs because of localized corrosion. Discoloration, pitting attack, and penetration or perforation of stainless steels tend to take place on broad surfaces with low fluid flow rates, while some form of crevice corrosion takes place where there are imperfect contacts with mud, fouling substances, wood, paint, or other bodies, or even where there are reentrant angles or corners.

For example, the use of austenitic stainless steels for service in strong chloride environments has been difficult due to the possibility of chloride stress corrosion cracking. Under conditions of even moderate stress and temperature, type 304 (ordinarily 18% Cr 8% Ni) stainless steel will crack at very low chloride levels. Moreover, some of the metals used in prior art are magnetic. It is theoretically possible that a magnetic mine or similar magnetic object would be attracted to a current urn disposed in the sea.

Therefore, a need exists to have corrosion resistant cremation urns for our loved ones and animals of loved ones that can withstand a variety of environments, including outdoor, semi-outdoor, and water environments. A needs exists to be able to provide for a material that is lightweight while offering the mobility and portability needed in cremation urns. In fact, a need exists for a lightly made material that is nearly half the density of other metallic urns to provide for this mobility and portability.

Titanium and its alloys are known in the industry to be resistant to corrosion. When exposed to oxygen, titanium is very reactive and tends to form a thin film of titanium oxide. This film is what gives titanium its strong resistance to corrosion. The layer of oxide even has the ability to “heal” itself after it has been scratched. After the metal has been scratched, a new layer of oxide will quickly form. Titanium is very stable over a wide range of pH and temperatures. For example, near nil corrosion has been shown in brine solutions ranging in pH from 3 to 11. In seawater, titanium has a corrosion rate of less than 0.0003 millimeters per year (mmpy). Also, the cracking problem that occurs with stainless steel is near non-existent with most commercial grade titanium and its alloys.

Titanium's corrosive abilities depend greatly on what other metals are contained in the alloy. For example, unalloyed titanium is virtually impervious to crevice corrosion up to 185° F. in organic type environments. By introducing molybdenum, palladium, and/or ruthenium to the titanium, the corrosion resistance is significantly increased beyond 185° F. Aluminum, vanadium, and other beta alloying elements can be added in order to make an alloy obtain higher mechanical properties.

Titanium's resistance to atmospheric, marine, groundwater, and biological microorganism corrosion has led to commercial exploitation of the material. Titanium has become a popular architectural resource. Additionally, titanium has been studied as possible urns for highly corrosive environments. In one instance, titanium urns are seen as a possible alternative to store nuclear waste. Also, the sewage control industry has studied the viability of using titanium urns. The food and drug industry has begun to study the viability of titanium cremation urns. Titanium has been found to work well in the storage of food products because of its high resistance to corrosion and low propensity for contamination. Consequently, the quality of the stored product is maintained.

The commercial applications of titanium have not been fully exploited. The death care industry has yet to fully appreciate the benefits of titanium. The same qualities of titanium that have benefited other industries can benefit the death care industry. Loved ones can rest assured knowing that the deceased will be in a cremation urn whose quality will not diminish over time.

### SUMMARY OF THE INVENTION

The present invention offers corrosion resistant lightweight titanium cremation urns that may be used in a variety of environments, including outdoor, semi-outdoor, water, and marine environments without the concern of corrosion and fermentation problems seen in the prior art.

In a most preferred embodiment, an urn formed of titanium offers a preferred urn for the cremated remains of a deceased human or animal. In a most preferred embodiment, the urn may further include a compartment for the inclusion of objects. Titanium and its alloys can be applied to the surface of a metallic urn by ion nitriding, implantation, plasma spraying, and or plating.

Titanium and its principal alloys taught in this invention are nonmagnetic, virtually immune to corrosive elements such as seawater, and relatively lightweight. The urn may include other alloying elements such as aluminum, iron, manganese, niobium, palladium, ruthenium, silicon, tantalum, tin, vanadium, and/or yttrium.

### BRIEF DESCRIPTION OF THE DRAWINGS

The accompanying drawings, which are incorporated in and form a part of the specification, illustrate the embodiments of the present invention, and, together with the description, serve to explain the principles of the invention. In the drawings:

FIG. 1 is a side view of an embodiment of a assembled urn for a deceased person or animal;

FIG. 2 is a side view an embodiment of a assembled urn for a deceased person or animal;

FIG. 3 is a top view an embodiment of a assembled urn for a deceased person or animal;

FIG. 4 is a side view an embodiment of a assembled urn for a deceased person or animal;

FIG. 5 is an exploded, cross-sectional side view of a portion of an embodiment of a urn for a deceased person or animal;

FIG. 6 is a side view of another embodiment of a urn for a deceased person or animal;

FIG. 7 is an exploded, cross-sectional side view of an embodiment of a urn for a deceased person or animal;

FIG. 8 is a cross-sectional, side view an embodiment of a assembled urn for a deceased person or animal;

FIG. 9 is bottom view an embodiment of a assembled urn for a deceased person or animal;

FIG. 10 is an exploded, side view of an embodiment of a urn for a deceased person or animal at least partially disposed in the ground;

FIG. 11 is an exploded, side view of an embodiment of a urn for a deceased person or animal including an embodiment of a chamber; and

FIG. 12 is a side view of an embodiment of a urn for a deceased person or animal including an embodiment of a chamber.

It is to be noted that the drawings illustrate only typical embodiments of the invention and are therefore not to be considered limiting of its scope, for the invention encompasses other equally effective embodiments.

### DETAILED DESCRIPTION OF PREFERRED EMBODIMENT

The present invention is described with reference to a preferred embodiment of a corrosion resistant urn capable of holding a deceased person or animal. These embodiments show urns in the forms of urns for containing the cremated remains of a human or animal.

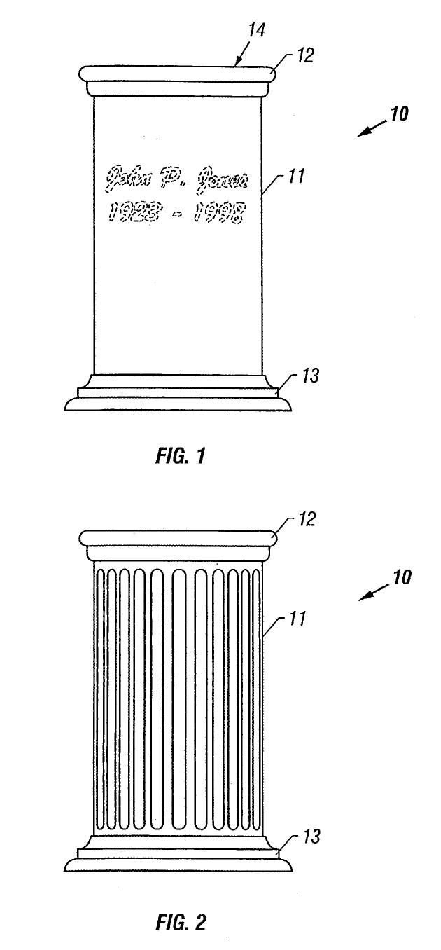

As shown in FIG. 1, a side view of an assembled, preferred embodiment of a urn 10 is displayed. Urn 10 typically comprises a body 11, a cap 12, and a second cap sometimes referred to as a base 13. As shown herein, a variety of designs or shapes may be incorporated into body 11, a cap 12, and a base 13. A preferred shape for body 11 is a cylinder having a cavity formed within body 11 capable of holding the remains of at least one deceased human or animal. This body 11 may be attached, secured, or otherwise connected to each cap 12 and base 13.

Body 11 may be formed in any shape. The cylindrical shape shown in FIG. 1 is preferable for strength and ease of formation. The indicia or writing shown on body 11 is only illustrative of the identification, stylistic, or ornamental materials that may be displayed on body 11. Referring to FIG. 2, another side view of an embodiment is shown. The ornamental design of body 11 of urn 10 shows some of the possibilities in design that may incorporated into the urn for stylistic, ornamental, or aesthetic purposes.

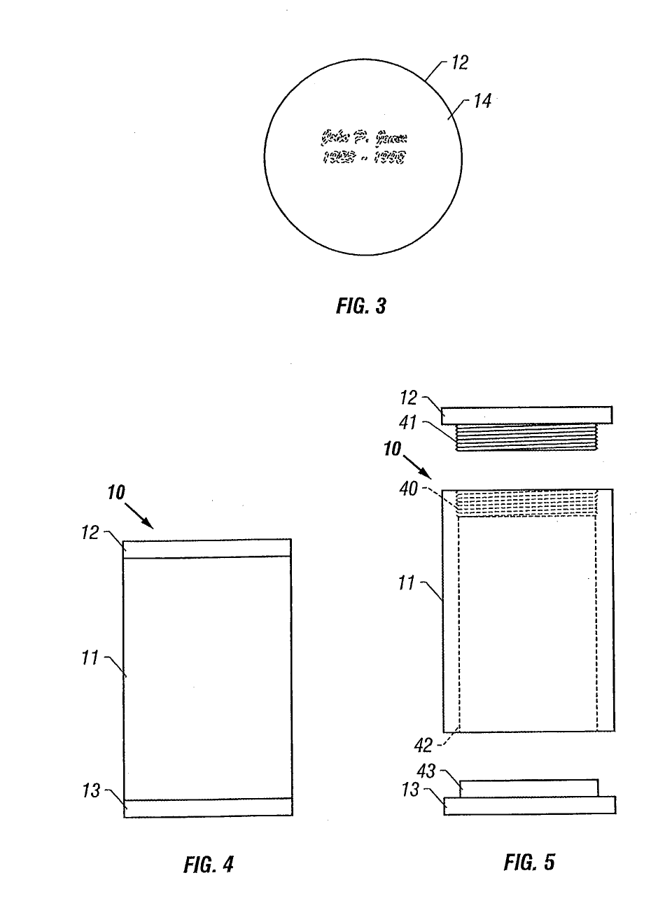

It is envisioned that visual indicia may include script or other written information that may include identification information, pictures, scenes, designs, or even portraits or pictures. Though discussed in greater detail below, any visual indicia on any portion of the urn 10 may be applied by any method known to those skilled in the art including but not limited to milling, etching, laser etching, chemical etching, machining, chemical milling, cold or hot working blasting processes such as peening, and/or blasting. In this embodiment, indicia or writing may be disposed on other parts of the invention, such as the top surface 14 of the cap 12 as shown in FIG. 3, a top view of the urn 10.

As shown in an assembled and a cross-sectional, exploded condition in FIGS. 4 and 5, respectively, the urn 10 has a body 11 that is preferably formed with threads 40 formed in top portion of body 11. These threads 40 offer a preferred mechanism for securing the cap 12, also having threads 41 formed therein, to the body 11. Additional methods of securement are disclosed herein. In the event that a second cap is used, herein base 13, it may be connected to the body 11 in a similar manner. In this embodiment, the bottom portion 42 of body 11 is formed such that it may engage the top portion 43 of base 13 in a press-fit engagement. Those skilled in the art will recognize that virtually any means of securing each cap and base to the body 11 is considered to be within the scope of the invention. By example only, it is envisioned that bolts, fasteners, welds, press or shrink fit, screws, hinges, adhesives, and similar securing means are within the scope of the invention. A sealed or leak proof urn 10 capable of preventing fluids from entering of exiting the urn 10 is shown herein. Additionally, an urn 10 that does not provide this leak proof seal is considered to be within the scope of the invention. It is envisioned that forming a titanium or titanium alloy urn 10 is within the scope of the invention as disclosed and claimed herein. The leak proof seal disclosed herein is one embodiment, though the inventive use of titanium and titanium alloys is common to the urns 10 described herein.

If included, the second cap referred to as base 13 is preferably formed such that it provides a foundation for the urn 10 to be placed or rest upon another surface. Base 13 may be formed in an endless variety of shapes. For example, it may be preferable for base 13 to include a flat surface such that urn 10 may be placed on a mantle. In the alternative, base 13 may include a spike, bolt, or similar anchoring mechanism capable of securing urn 10 in place. In a most preferred embodiment, base 13 of urn 10 comprises a securing shape such that urn 10 may be secured on the bottom of the ocean.

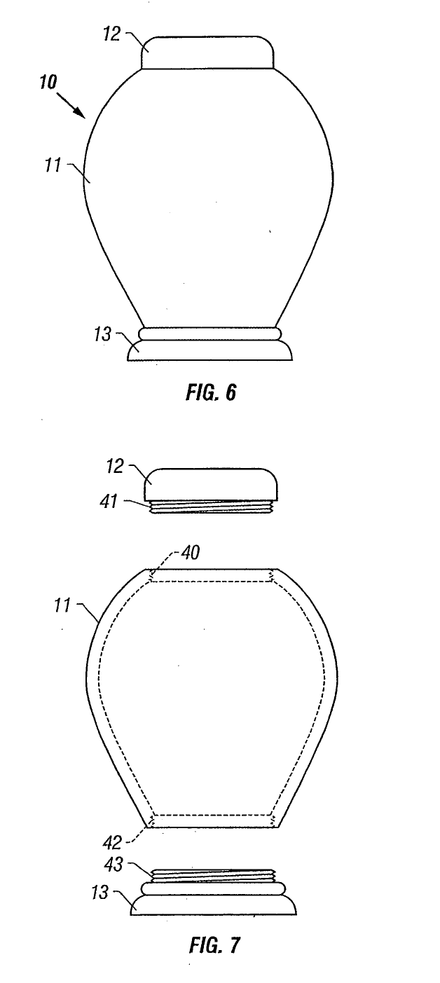

In addition to this embodiment, numerous other embodiments of urn 10 may be formed that are within the scope of the invention. For example, FIGS. 6 and 7 show an alternative embodiment in a side view and a cross-sectional, exploded condition, respectively. Notably, the threaded engagement of the bottom portion 41 of cap 12 with the top portion 40 of body 11 is replicated in the second cap, base 13 wherein the bottom portion 42 of body 11 may engage the top portion 43 of base 13 in a threaded engagement. Those skilled in the art will recognize that this embodiment could also benefit from the inclusion of visual indicia or identification as previously discussed.

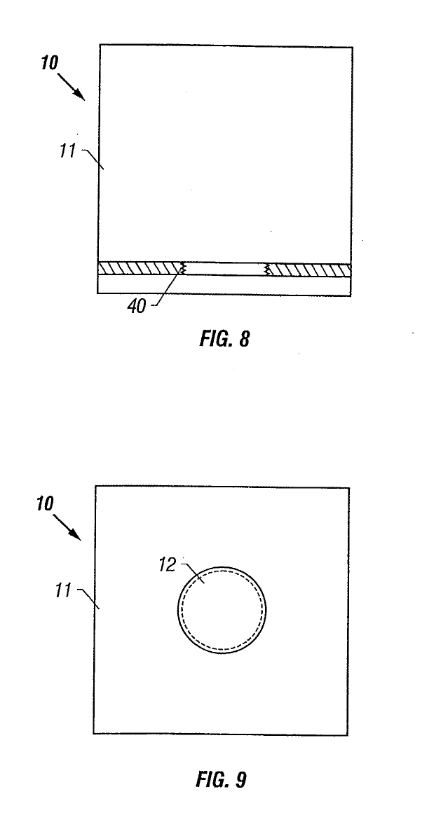

Additionally, another embodiment is shown in FIGS. 8 and 9 wherein the urn 10 is shown in a cross-sectional side view and a bottom view, respectively. This embodiment illustrates the scope of the invention by showing that the body 11 may be formed in a variety of forms such that a single cap 12 may be disposed with body 11 to form the sealed condition. By forming the body 11 as such, the cap 12 may be engaged with the body 11, herein shown by illustration as a threaded engagement, to form the seal discussed herein.

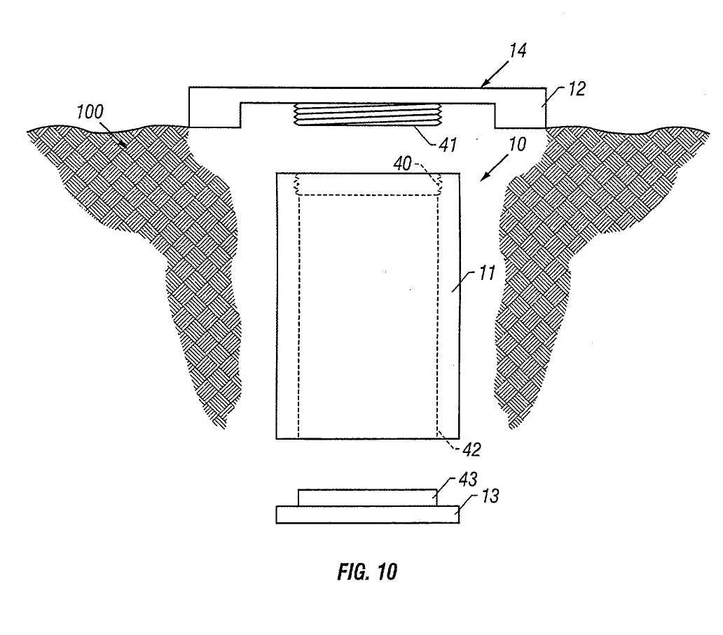

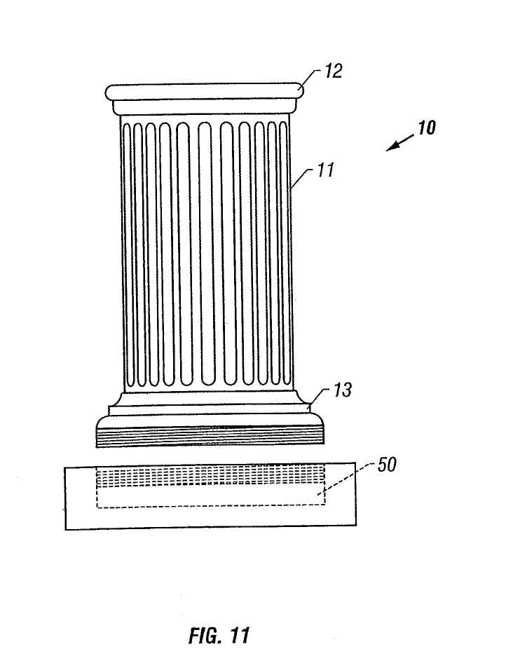

FIG. 10 shows a urn 10 at least partially disposed in the ground 100. It is envisioned that at least one visual indicia may be disposed on the top 14 of the cap 12 such that identification or ornamental aspects may be shown therein. The corrosion resistant characteristics of the urn 10 will allow the urn 10 to be disposed in this outdoor environment for extended periods.

There are several ways to make this urn. One method would be to use tubular rolled sheets of titanium alloy, which can then be cut and welded together into the desired shape. Another possible method would be to the process of hot working extruded pieces. Additionally, it may be machined from a solid bar. Yet another method would be to cast the appropriate shape. A preferred method of forming the urn is rendering a hot-formed tube through the extrusion or piercing process. Subsequent operations, such as heat treatment and final conditioning to the titanium surface, would be applicable. Machining and or grinding would determine the final dimension of the urn. Blasting the surface urn can generate a texture conducive to the retail market.

The caps may be cast or machined from a solid bar. Those skilled in the art will recognize that these methods are illustrative of the methods of making the present invention and the scope should not be limited thereto.

Titanium alloys come in many varied forms. The following metals can be combined with titanium to form commercially functional alloys: aluminum (Al), chromium (Cr), cobalt (Co), iron (Fe), manganese (Mg), molybdenum (Mo), nickel (Ni), niobium (Nb), palladium (Pa), ruthenium (Ru), silicon (Si), tantalum (Ta), tin (Sn), vanadium (V), yttrium (Y), zirconium (Zr). Some of these alloys include: Alpha Alloys such as ASTM Grade 12, 5AL-2.5SN, 5AL-2.5SN-(ELI), 5AL-5ZR-5SN, 8AL-1MO-1V; Beta Alloys such as 3AL-8V-6CR-4MO-4Z, 15V-3AL-3CR-3SN, Timet's Alloy sold under the trademark BETA 21-S, LCB, 13V-11CR-3AL; Alpha-Beta Alloys such as, 3AL-2.5V, 10V-2FE-3AL, 6AL-2SN-4ZR-2MO, 6AL-4V, 6AL-4V-(ELI), 6AL-6V2SN, 6AL-2SN-2ZR-2MO-2CR, 6AL-2SN-4ZR-6MO, 6AL-7NB, 7AL-4MO, 8MN; and/or commercially pure Grades such as commercially pure ASTM Grade 1, Grade 2, Grade 3, Grade 4, Grade 7, Grade 13, Grade 14, Grade 15, Grade 16, Grade 17 and Grade 18. Titanium and titanium alloys as the whole or as a coating offer advantages over the prior art.

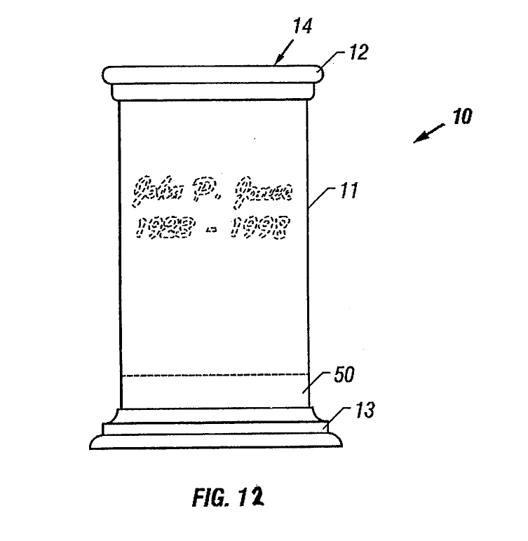

In a most preferred embodiment, the urn may further include a compartment 50 for the inclusion of objects as shown in FIGS. 11 and 12. The compartment 50 should be versatile enough to hold many kinds of objects. One such object would be a small family heirloom. Perhaps an object that was significant to the deceased (i.e. jewelry, pictures). Additionally, the compartment 50 would be able to hold a DNA sample such as a lock of hair. The compartment's 50 function is to act as a time capsule. Therefore, anything that would be significant to give information to future people might be included. Additionally, the inclusion of visual indicia including but not limited to etching such as laser etching is within the scope of the invention. Different techniques include but are not limited to milling, blasting, chemical etching, and similar methods. An example of the possible etching is shown in FIG. 1.

Having described the invention above, various modifications of the techniques, procedures, material and equipment will be apparent to those in the art. It is intended that all such variations within the scope and spirit of the appended claims be embraced thereby.

What is claimed is:

1. A titanium cremation urn capable of holding the remains of a deceased human or animal wherein the urn consists of titanium or titanium alloy.

2. The urn of claim 1 further comprising at least one visual indicia.

3. The urn of claim 1 comprising a body and at least one cap, wherein the cap is capable of a leak proof seal to the body.

4. The urn of claim 1, wherein the urn is not sealed.

5. The urn of claim 1, further comprising at least one compartment.

6. A titanium cremation urn capable of holding the remains of a deceased human or animal wherein the urn comprises a coating wherein the coating consists of titanium or titanium alloy.

7. The urn of claim 6 comprising at least one visual indicia.

8. The urn of claim 6, wherein the urn comprises a base cap wherein the base cap is capable of a leak proof seal to the body.

9. The urn of claim 6, wherein the urn is not sealed.

10. The urn of claim 6, further comprising at least one compartment.

11. A titanium cremation urn capable of holding the remains of a deceased human or animal wherein the urn comprises titanium or titanium alloy.

12. The urn of claim 12 comprising a body and at least one cap, wherein the cap is capable of a leak proof seal to the body.

13. A method of making a titanium cremation urn capable of containing the remains of a deceased human or animal which comprises the steps of:
(a) forming a body;
(b) forming at least one cap; and
(c) engaging each cap to the body;
wherein the body and each cap consists of titanium or a titanium alloy.

14. The method of claim 13, wherein Step (a) further comprises rolling a sheet to form a tubular shape body.

15. The method of claim 13, which further comprises blasting after Step (c).

16. A method of using a titanium cremation urn capable of holding the remains of a deceased human or animal, the method which comprises the steps of:
(a) placing the remains in the urn; and
(b) sealing the urn;
wherein the urn consists of titanium or a titanium alloy.

17. The method of claim 14, which further comprises:
(c) placing the urn in an outdoor, semi-outdoor, water, or marine environment.

18. A method of using a titanium cremation urn capable of holding the remains of a deceased human or animal, the method which comprises the steps of
(a) placing the remains in the urn; and
(b) sealing the urn;
wherein the urn comprises titanium or a titanium alloy.

19. The method of claim 18, which further comprises:
(c) placing the urn in an outdoor, semi-outdoor, water, or marine environment.
